(19) United States
(12) Patent Application Publication
(10) Pub. No.: US 2007/0088143 A1
(43) Pub. Date: Apr. 19, 2007

(54) Alpha, alpha-dihydrofluorovinyl ethers, homopolymers and copolymers thereof

(76) Inventors: Ming-Hong Hung, Wilmington, DE (US); Phan Linh Tang, West Chester, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 11/498,907

(22) Filed: Aug. 3, 2006

Related U.S. Application Data
(60) Provisional application No. 60/728,169, filed on Oct. 19, 2005.

(51) Int. Cl. C08F 16/24

(52) U.S. Cl. 526/247

(57) ABSTRACT

Disclosed herein are novel α,α-dihydrofluorovinyl ethers, homopolymers thereof and copolymers containing more than 22 mole percent copolymerized units of said ether. The ethers have the general formula R_{f}—[CH₂]ₙ-OCF═CF₂, wherein n is 1 or 2, and R_{f} is selected from the group consisting of a perfluoroalkyl group, a perfluoroalkoxy group, a fluoroalkyl group and a fluoroalkoxy group.

### CROSS REFERENCE TO RELATED APPLICATIONS

This application claims the benefit of U.S. Provisional Application No. 60/728,169 filed Oct. 19, 2005.

### FIELD OF THE INVENTION

This invention relates to certain α,α-dihydrofluorovinyl ethers, homopolymers and copolymers thereof.

### BACKGROUND OF THE INVENTION

Elastomeric fluoropolymers (i.e. fluoroelastomers) exhibit excellent resistance to the effects of heat, weather, oil, solvents and chemicals. Such materials are commercially available and are most commonly copolymers of vinylidene fluoride (VF₂) with hexafluoropropylene (HFP) and, optionally, tetrafluoroethylene (TFE). Other known fluoroelastomers include copolymers of TFE with a perfluoro(alkyl vinyl ether) such as perfluoro(methyl vinyl ether) (PMVE), copolymers of TFE with propylene (P) and, optionally VF₂, and copolymers of ethylene (E) with TFE and PMVE. Often, these fluoroelastomers also contain copolymerized units of a cure site monomer to facilitate vulcanization. While these copolymers have many desirable properties, including low compression set and excellent processability, their low temperature flexibility is not adequate for all end use applications. One particularly desirable improvement would be a reduction in glass transition temperature (T_{g}) with an accompanying extension of service temperature to lower temperatures. T_{g} is often used as an indicator of low temperature flexibility because polymers having low glass transition temperatures maintain elastomeric properties at low temperatures.

U.S. Pat. No. 5,268,405 discloses fluoroelastomers blended with a perfluoropolyether in order to reduce the T_{g} of the composition. However, when such compositions are exposed to high temperatures, the perfluoropolyethers tend to be fugitive. As the level of perfluoropolyether in the compositions decreases, the T_{g} reverts to that of compositions containing no perfluoropolyether.

In order to lower the T_{g} of fluoroelastomers, others have copolymerized into the elastomer chain a perfluoro(alkyl vinyl ether) having more than one —C—O—C— sequence. For example, U.S. Pat. No. 4,513,128 discloses fluoroelastomers containing 5 to 50 mole percent copolymerized units of perfluorovinylpolyether having the formula CF₂═CFO—[CF₂CF(CF₃)O]ₙR_{f} wherein R_{f} is a C₁₋₁₂ perfluoroalkyl group and n is an integer from 3 to 30. Such fluoroelastomers have a T_{g} between −15° C. and −100° C. Polyethers having an n value of 0 to 2 are said to have very little effect on T_{g}. The glass transition temperature decreases with increasing level of copolymerized perfluorovinylpolyether units and with increased values of n. However, it is difficult to copolymerize moderate or high levels of perfluorovinylpolyether units into the fluoroelastomer due to the poor solubility of the polyethers in water and the relatively slow polymerization reaction kinetics of the ether. Chlorofluorocarbons such as F-113 may be employed as a polymerization solvent. However, such solvents have environmental problems due to their ozone depletion potential. Also, incorporation or conversion of perfluorovinylpolyether units into the elastomer is less in a chlorofluorocarbon solvent than it would be in an emulsion polymerization process if the polyether could be sufficiently emulsified.

U.S. Pat. No. 6,730,760 discloses an emulsion polymerization process for making fluoroelastomers containing 10-60 mole percent of a perfluorovinyl ether of the formula CF₂═CF[O(CF₂)ₙ]ₘ(OCF₂)ₓOR_{f}, wherein n is an integer from 1-6, m is an integer from 1-3, x an integer from 0-3 and R_{f} is a C₁₋₆ perfluoroalkyl group. The perfluorovinyl ether is pre-emulsified with a surfactant prior to copolymerization with the comonomers. However, it is difficult to manufacture the latter perfluorovinyl ether. Typically, direct fluorination or electrochemical fluorination must be employed. Also polymerization reaction kinetics are relatively slow due to the ether.

### SUMMARY OF THE INVENTION

It has been surprisingly discovered that the glass transition temperature of fluoroelastomers may be significantly reduced when more than 22 mole percent of a certain α,α-dihydrofluorovinyl ether is copolymerized into the fluoroelastomers. Homopolymers of the α,α-dihydrofluorovinyl ethers also have good low temperature properties. The α-hydrogen atoms on these ethers activate the C—C double bonds resulting in excellent polymerization activity.

Accordingly, the present invention is directed to an α,α-dihydrofluorovinyl ether having the general formula R_{f}—[CH₂]ₙ-OCF═CF₂, wherein n is 1 or 2, and R_{f} is selected from the group consisting of a perfluoroalkoxy group and a fluoroalkoxy group.

Another aspect of the present invention is a homopolymer of an α,α-dihydrofluorovinyl ether having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group.

Another aspect of the invention is a fluoroelastomer copolymer comprising:

A) more than 22 mole percent of copolymerized units of an α,α-dihydrofluorovinyl ether monomer having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group; and

B) copolymerized units of at least one other copolymerizable monomer, said mole percent based on total moles of all copolymerized monomers in said copolymer.

Another aspect of the invention is a process for the preparation of a fluoroelastomer comprising:
A) emulsifying a mixture comprising i) an α,α-dihydrofluorovinyl ether having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group; ii) surfactant and iii) water to form an emulsified α,α-dihydrofluorovinyl ether; and
B) copolymerizing said emulsified α,α-dihydrofluorovinyl ether with at least one gaseous fluoromonomer to form a fluoroelastomer.

### DETAILED DESCRIPTION OF THE INVENTION

The novel α,α-dihydrofluorovinyl ethers of this invention have the general formula R_{f}—[CH₂]ₙ—OCF═CF₂, wherein n is 1 or 2 (preferably is 1), and R_{f} is selected from the group consisting of a perfluoroalkoxy group and a fluoroalkoxy group. Specific examples include, but are not limited to CH₃O—(CF₂)₂—CH₂—OCF═CF₂; CF₃O—(CF₂O)ₚ—CF₂—CH₂—OCF═CF₂ (p is an integer between 1 and10); and C₃F₇O—[CF(CF₃)CF₂O]_{q}—CF(CF₃)—CH₂—OCF═CF₂ (q is an integer between 1 and 20).

In addition to the novel α,α-dihydrofluorovinyl ethers mentioned above, other α,α-dihydrofluorovinyl ethers that may be employed in the homopolymers and copolymers of this invention include those of the above general formula wherein the R_{f} group may also be selected from the group consisting of a perfluoroalkyl group (preferably containing at least 4 carbon atoms) and a fluoroalkyl group (preferably containing at least 4 carbon atoms). Specific examples of such ethers include CF₃CF₂CF₂CF₂CH₂—OCF═CF₂ and H—CF₂CF₂CF₂CF₂—CH₂OCF═CF₂. However, homopolymers and copolymers based on α,α-dihydrofluorovinyl ethers having an R_{f} group selected from the group consisting of a perfluoroalkoxy group and a fluoroalkoxy group are preferred.

All these α,α-dihydrofluorovinyl ethers may readily be synthesized from the corresponding alcohols or esters. For example
CF₃CF₂CF₂CF₂CH₂OH+NaH→[CF₃CF₂CF₂CF₂CH₂O—Na]+tetrafluoroethylene (TFE)→CF₃CF₂CF₂CF₂CH₂—OCF═CF₂
CF₃CF₂CF₂—O—CF(CF₃)CF₂—O(CF₃)CF—CH₂—OH+NaH/TFE→CF₃CF₂CF₂—O—CF(CF₃)CF₂—O(CF₃)CF—CH₂—OCF═CF₂
CH₃O—CF₂CF₂—COOMe+LiAlH₄→CH₃O—CF₂CF₂—CH₂OH
CH₃O—CF₂CF₂—CH₂OH+NaH/TFE→CH₃O—CF₂CF₂—CH₂OCF═CF₂

Homopolymers of the invention may be made by either solution or emulsion polymerization of the corresponding α,α-dihydrofluorovinyl ether. Polymerization may be initiated by an inorganic peroxide such as ammonium persulfate or by an organic peroxide such as 4,4′-bis(t-butylcyclohexyl)peroxy dicarbonate.

The preferred method for manufacturing the fluoroelastomers of this invention is emulsion polymerization so that conversion is high and chlorofluorocarbon solvents are not necessary. However, the α,α-dihydrofluorovinyl ethers employed in the fluoroelastomers of this invention are not very soluble in water. In order to incorporate sufficient copolymerized units of the α,α-dihydrofluorovinyl ethers into the fluoroelastomer and lower the elastomer's T_{g}, the α,α-dihydrofluorovinyl ethers should be emulsified prior to introduction of gaseous monomers and initiator to the reactor.

In a preferred polymerization process, a mixture comprising i) an α,α-dihydrofluorovinyl ether; ii) a fluorosurfactant and iii) water is first emulsified. A mixer such as a Microfluidizer® High Shear Processor (available from Microfluidics, a division of MFIC Corp.) facilitates emulsion preparation. It is critical that this emulsified mixture not contain gaseous comonomer. The mixture may further contain other ingredients such as a cure site monomer, pH buffer (e.g. sodium phosphate dibasic heptahydrate), and a fluorinated solvent such as a fluorinated alcohol (e.g. hexafluoroisopropanol) to assist in the emulsification of the α,α-dihydrofluorovinyl ether. The maximum droplet size of the α,α-dihydrofluorovinyl ether is preferably less than 1 micron.

The resulting emulsified α,α-dihydrofluorovinyl ether is then copolymerized in a conventional emulsion polymerization process with at least one gaseous fluoromonomer to form a fluoroelastomer.

Fluoroelastomer copolymers of this invention comprise more than 22 (preferably more than 25) mole percent copolymerized units of an α,α-dihydrofluorovinyl ether monomer as defined above; and copolymerized units of at least one other copolymerizable monomer. Mole percent is based on the total number of moles of copolymerized monomer units in the copolymer. Copolymerizable monomers include, but are not limited to tetrafluoroethylene (TFE), chlorotrifluoroethylene (CTFE), hexafluoropropylene (HFP), vinylidene fluoride (VF₂), perfluoro(methyl vinyl ether) (PMVE), perfluoro(propyl vinyl ether) (PPVE), ethylene (E) and propylene (P) as well as functional monomers such as CF₂═CFOCF₂CF(CF₃)—O—CF₂CF₂—COOCH₃, CF₂═CFOCF₂CF(CF₃)—O—CF₂CF₂—SO₂F and other monomers such as CF₂═CFO—[CF₂CF(CF₃)O]ₙR_{f} wherein n is an integer between 1 and 6 and R_{f} is perfluoroalkyl or perfluoroalkoxy group containing between 1 and 8 carbon atoms.

In addition, copolymers of the invention may contain 0.1 to 7 mole percent copolymerized units of cure site monomers commonly employed in the fluoropolymer industry. Such cure site monomers include, but are not limited to bromine- and iodine-containing olefins such as bromotrifluoroethylene, iodotrifluoroethylene, 4-bromo-3,3,4,4-tetrafluorobutene, and 4-iodo-3,3,4,4-tetrafluorobutene. Such cure site monomers are well known in the art (e.g. U.S. Pat. Nos. 4,214,060; 5,214,106; and 5,717,036). Other cure site monomers include 2-hydropentafluoropropene, 1-hydropentafluoropropene; 3,3,3-trifluoropropene; and nitrile group-containing fluoroolefins or fluorovinyl ethers such as those disclosed in U.S. Pat. No. 6,211,319 B1 (e.g. perfluoro(8-cyano-5-methyl-3,6-dioxa-1-octene)).

Fluoroelastomer copolymers of this invention may be prepared by known emulsion, suspension or solution polymerization processes. A chain transfer agent such as a perfluoroalkyldiiodide (e.g. I—(CF₂)₄—I), alcohols, ketones or hydrocarbons may be employed to control the polymerization.

Specific examples of fluoroelastomers of this invention include, but are not limited to elastomers comprising copolymerized units selected from the group consisting of a) 25-76% VF₂/10-50% HFP/26-65% DHFVE, b) 25-64% VF₂/5-46% HFP/5-30% TFE/26-65% DHFVE, c) 25-64% VF₂/10-49% PMVE/26-65% DHFVE, d) 25-64% VF₂/5-44% PMVE/5-30% TFE/26-65% DHFVE, e) 5-30% VF₂/2040% TFE/1040% P/26-65% DHFVE; f) 20-40% TFE/15-40% P/26-65% DHFVE; g) 10-30% E/15-40% TFE/10-20% PMVE/26-65% DHFVE and h) 15-44% TFE/20-45% PMVE/26-65% DHFVE. All percentages in fluoroelastomers a)-h) are mole percentages based on the total moles of copolymerized comonomer units. In each case DHFVE stands for an α,α-dihydrofluorovinyl ether. These elastomers may further comprise at least one type of cure site as described above.

α,α-Dihydrofluorovinyl ethers of the present invention are useful as monomers for the preparation of fluoropolymers. Homopolymers of α,α-dihydrofluorovinyl ethers are useful as coating materials. Copolymers of the present invention are useful in production of gaskets, tubing, seals and other molded components. Such articles are generally produced by compression molding a compounded formulation of the elastomer, a curing agent and various additives, curing the molded article, and then subjecting it to a post cure cycle. The cured parts have excellent low temperature flexibility and processability as well as excellent thermal stability and chemical resistance. They are particularly useful in applications such as seals and gaskets requiring a good combination of oil resistance, fuel resistance and low temperature flexibility, for example in fuel injection systems, fuel line connector systems and in other seals for high and low temperature automotive uses.

The invention is now illustrated by certain embodiments wherein all parts and percentages are by weight unless otherwise specified.

### EXAMPLES

### Example 1

2,2,3,3-tetrafluoro-3-methoxypropyl trifluorovinyl ether [CH₃O—CF₂CF₂—CH₂OCF═CF₂] was prepared from methyl 3-methoxy-2,2,3,3-tetrafluoropropionate via 3-methoxy-2,2,3,3-tetrafluoro-1-propanol intermediate.

Preparation of 3-methoxy-2,2,3,3-tetrafluoro-1-propanol [CH₃O—CF₂CF₂—CH₂OH]: To a lithium aluminum hydride (45.6 g, 0.20 mol) suspension in anhydrous ether (1.0 liter) solvent was added slowly methyl 3-methoxy-2,2,3,3-tetrafluoropropionate (275 g, 1.45 mol, available from DuPont) while the reaction temperature was controlled at <15° C. with external cooling. After the addition was completed, the reaction mixture was allowed to stir at ambient temperature for 2 hours. The product mixture was poured slowly into a 6N hydrochloric acid solution. The organic layer was separated, dried over magnesium sulfate, and distilled to give the product as a clear, colorless liquid. Boiling point: 142-144° C., yield was about 130 grams. ¹H NMR (CDCl₃, 400 MHz): 63.96 (t, J=14.4 Hz, 2H), 3.68 (s, 3H), 2.53 (s, 1 H); ¹⁹F NMR (CDCl₃, 376.89 MHz): −92.9 (s, 2F), −126.7 (tt, J=4.0 Hz, 14.4 Hz, 2F).

Preparation of 2,2,3,3-tetrafluoro-3-methoxypropyl trifluorovinyl ether [CH₃O—CF₂CF₂—CH₂OCF═CF₂]: Sodium hydride (60% oil suspension, 30 g, 0.75 mol) was suspended in anhydrous ether (450 mL). 3-Methoxy-2,2,3,3-tetrafluoro-1-propanol (97.2 g, 0.60 mol) was added slowly with vigorous stirring. When the addition was completed, the mixture was allowed to stir at ambient temperature for 1-2 hrs. The mixture was transferred into a 1300 ml shaker tube under nitrogen stream and was heated at 60° C. for 16 hrs. After cooling and evacuation, tetrafluoroethylene (TFE) gas was added to reach a pressure of 400 psig (2.76 MPa). The tube was then sealed and agitated at 50° C. for 24 hrs. The TFE pressure was maintained at 400 psig (2.76 MPa) during the reaction process. After cooling, the product was filtered to remove any solid residue, and dumped into water. The organic layer was separated and washed with fresh water. After removing the ether solvent in vacuo, the material was distilled to give the product as a clear, colorless liquid. Boiling point: 58° C. at 80 mmHg. Three runs and a combined distillation gave about 195 g of product. ¹H NMR (CDCl₃, 400 MHz): δ4.29 (t, J=13.6 Hz, 2H), 3.68 (s, br, 3H); ¹⁹F NMR (CDCl₃, 376.89 MHz): −93.0 (s, br, 2F), −125.4 (m, br, 2F), −122.2 (4m, 1F), −128.2 (t, J=4.6 Hz, 1F), -137.7 (4s, 1F). IR(neat): 1842 cm⁻¹.

### Example 2

Preparation of 2,2,4,4,6,6,8,8,8-nonafluoro-3,5,7-trioxa-octyl trifluorovinyl ether [CF₃O—(CF₂O)₂—CF₂CH₂—OCF═CF₂] was prepared from 2,2,4,4,6,6,8,8,8,-nonfluoro-3,5,7-trioxa-1-octanol by reaction with sodium hydride and TFE. The product was a clear, colorless liquid. Boiling point: 57° C. at 70 mmHg. ¹H NMR (CDCl₃, 400 MHz): 64.25 (t, J=9.5 Hz); ¹⁹F NMR (CDCl₃, 376.89 MHz): −54.0 (m, 2F), −56.0 (m, 2F), −57.5 (m, 3F), −80.6 (m, 2F), −121.4 (4s, 1F), −127.3 (4s, 1F), −137.9 (4m, 1F).

### Example 3

Homopolymerization of α,α-dihydrofluorovinyl ether monomers. In a typical polymerization, CH₃—O—CF₂CF₂CH₂—O—CF═CF₂ was polymerized as described below:

In a one-liter reactor was charged deionized water (550 mL), the ammonium salt of perfluorononanoic acid (surfactant, 3.0 g), disodium phosphate heptahydrate (2.0 g) and ammonium persulfate (0.4 g), along with the 2,2,3,3-tetrafluoro-3-methoxypropyl trifluorovinyl ether monomer (30 g). The reactor was sealed and cool-evacuated several times. By “cool-evacuated” is meant that oxygen was removed from the reactor by cooling reactor contents sufficiently so that all ingredients remained in the reactor while a vacuum was applied to remove oxygen. The polymerization was run at 70° C. for 8 hrs. The resulting polymer latex was coagulated with saturated magnesium sulfate solution. The precipitated polymer was collected by filtration. The polymer was washed thoroughly with warm water, and then dried in a vacuum at 80° C. 26.2 grams of white polymer was obtained. It had a T_{g} of 16.5° C. as measured by DSC (Differential Scanning Calorimetry).

Other homopolymers were prepared by a similar process. Glass transition temperatures of the resulting homopolymers were measured by DSC. Results are shown in Table I.

TABLE I

| Polymerized Monomer | Tg, ° C. |
|---|---|
| CF₃—CH₂OCF═CF₂ | −6.8 |
| CF₃O—(CF₂O)₂—CF₂CH₂—OCF═CF₂ | 9.7 |
| CH₃O—CF₂CF₂—CH₂OCF═CF₂ | 16.5 |
| H—CF₂CF₂—CH₂—OCF═CF₂ | 27.4 |

### Example 4

Solution copolymerization of TFE/CH₃O—(CF₂)₂—CH₂—OCF═CF₂. In a 400 mL stainless steel shaker tube was charged 2,2,3,3-tetrafluoro-3-methoxypropyl trifluorovinyl ether (40 g), 1,1,2-trichloro-1,2,2-trifluoroethane (180 g) and 4,4′-bis(t-butylcyclohexyl)peroxy dicarbonate (0.1 g). The tube was cooled and evacuated several times, then TFE (12 g) was transferred into the tube. The tube was sealed and shaken at 70° C. for 8 hrs. After cooling, the solvent in the unloaded polymer solution was evaporated under vacuum. 42.0 grams of white polymer was obtained. This copolymer had a T_{g} of −1 5.7° C., as measured by DSC. The composition of the copolymer was 40.4 mol % TFE/59.6 mol % CH₃O—(CF₂)₂—CH₂—OCF═CF₂ as determined by F-NMR in hexafluorobenzene solvent at ambient temperature.

### Example 5

Copolymerization of TFE/CF₃CH₂—OCF═CF₂. In a 1-liter reactor was charged deionized water (550 mL), the ammonium salt of perfluorononanoic acid (surfactant, 3.0 g), disodium phosphate heptahydrate (2.0 g) and ammonium persulfate (0.3 g), along with the 3,3,3-trifluoroethyl trifluorovinyl ether (30 g). The reactor was sealed and cool-evacuated several times, then TFE (10 g) was transferred into the tube. The polymerization proceeded at 70° C. for 8 hrs. The resulting polymer latex was coagulated with saturated magnesium sulfate solution. The polymer precipitated was collected by filtration. The polymer was washed thoroughly with warm water, and then dried in a vacuum over at 80° C.; 36.1 grams of white polymer was obtained. This polymer had a Tg at 2.7° C. as measured by DSC. The polymer composition was 26.6 mol % TFE/73.4 mol % CF₃CH₂—OCF═CF₂ as analyzed by F-NMR in acetone-d₆ solvent at ambient temperature.

### Example 6

A polymer of the invention was prepared by a semi-batch emulsion polymerization process, carried out at 60° C. in a well-stirred reaction vessel. A 2-liter reactor was charged with an emulsion of 1200 g of deionized, deoxygenated water, 30 g of ammonium perfluorooctanoate, 6 g of sodium phosphate dibasic heptahydrate, and 90 g of CH₃O—CF₂CF₂—CH₂OCF═CF₂. The emulsion was prepared by passing the ingredients through a Microfluidizer® twice at about 103 MPa. The reactor was heated to 60° C. and then pressurized to 1.0 MPa with a monomer mixture of 60 wt. % vinylidene fluoride (VF₂) and 30 wt. % perfluoro(methyl vinyl ether) (PMVE). A 54.7 ml sample of a 0.001 wt. % ammonium persulfate initiator and 0.005 wt. % sodium phosphate dibasic heptahydrate aqueous solution was then added. VF₂ and PMVE were supplied to the reactor to maintain a pressure of 1.0 MPa throughout the polymerization. The initiator solution was fed continuously at 1.0 ml/hour through the end of the reaction period. After a total of 110 g monomer mixture had been supplied to the reactor, monomer addition was discontinued and the reactor was purged of residual monomer. The total reaction time was 27 hours. The resulting fluoroelastomer latex was coagulated by addition of an aqueous aluminum sulfate solution and the filtered fluoroelastomer was washed with deionized water. The polymer crumb was dried for two days at 60° C. The polymer, comprised of 66.7 mol. % VF₂, 13.1 mol. % PMVE and 20.2 mol. % CH₃O—CF₂CF₂—CH₂OCF═CF₂, was an amorphous fluoroelastomer having a glass transition temperature (T_{g}) of −32° C., as determined by differential scanning calorimetry (heating mode, 10° C./minute, inflection point of transition).

### Example 7

A polymer of the invention was prepared by a semi-batch emulsion polymerization process, carried out at 60° C. in a well-stirred reaction vessel. A 2-liter reactor was charged with an emulsion of 1200 g of deionized, deoxygenated water, 30 g of ammonium perfluorooctanoate, 6 g of sodium phosphate dibasic heptahydrate, and 110 g of CH₃O—CF₂CF₂—CH₂OCF═CF₂. The emulsion was prepared by passing the ingredients through a Microfluidizer® twice at about 103 MPa. The reactor was heated to 60° C. and then pressurized to 1.0 MPa with tetrafluoroethylene (TFE). A 54.7 ml aliquot of a 0.001 wt. % ammonium persulfate initiator and 0.005 wt. % sodium phosphate dibasic heptahydrate aqueous solution was then added. TFE was supplied to the reactor to maintain a pressure of 1.0 MPa throughout the polymerization. The initiator solution was fed continuously at 1.0 ml/hour through the end of the reaction period. After a total of 90 g TFE had been supplied to the reactor, monomer addition was discontinued and the reactor was purged of residual monomer. The total reaction time was 9 hours. The resulting fluoroelastomer latex was coagulated by addition of an aqueous aluminum sulfate solution and the filtered fluoroelastomer was washed with deionized water. The polymer crumb was died for two days at 60° C. The polymer, comprised of 33.6 mol. % TFE and 66.4 mol. % CH₃O—CF₂CF₂—CH₂OCF═CF₂, was an amorphous fluoroelastomer having a glass transition temperature of −23° C., as determined by differential scanning calorimetry (heating mode, 10° C./minute, inflection point of transition).

### Example 8

A polymer was prepared by a semi-batch emulsion polymerization process, carried out at 60° C. in a well-stirred reaction vessel. A 2-liter reactor was charged with an emulsion of 1200 g of deionized, deoxygenated water, 30 g of ammonium perfluorooctanoate, 6 g of sodium phosphate dibasic heptahydrate, and 124 g of CH₃O—CF₂CF₂—CH₂OCF⊚CF₂. The emulsion was prepared by passing the ingredients through a Microfluidizer® twice at about 103 MPa. The reactor was heated to 60° C. and then pressurized to 1.0 MPa with TFE. A 54.7 ml aliquot of a 0.001 wt. % ammonium persulfate initiator and 0.005 wt. % sodium phosphate dibasic heptahydrate aqueous solution was then added. TFE was supplied to the reactor to maintain a pressure of 1.0 MPa throughout the polymerization. The initiator solution was fed continuously at 1.0 ml/hour through the end of the reaction period. After a total of 76 g monomer mixture had been supplied to the reactor, monomer addition was discontinued and the reactor was purged of residual monomer. The total reaction time was 11 hours. The resulting fluoroelastomer latex was coagulated by addition of an aqueous aluminum sulfate solution and the filtered fluoroelastomer was washed with deionized water. The polymer crumb was dried for two days at 60° C. The polymer, comprised of 41.6 mol. % TFE and 58.4 mol. % CH₃O—CF₂CF₂—CH₂OCF═CF₂, was an amorphous fluoroelastomer having a glass transition temperature of −17° C., as determined by differential scanning calorimetry (heating mode, 10° C./minute, inflection point of transition).

### Example 9

A polymer was prepared by a semi-batch emulsion polymerization process, carried out at 60° C. in a well-stirred reaction vessel. A 2-liter reactor was charged with a an emulsion of 1200 g of deionized, deoxygenated water, 30 g of ammonium perfluorooctanoate, 6 g of sodium phosphate dibasic heptahydrate, and 96 g of CF₃CH₂—OCF═CF₂. The emulsion was prepared by passing the ingredients through a Microfluidizer® twice at about 103 MPa. The reactor was heated to 60° C. and then pressurized to 1.0 MPa with TFE. A 54.7 ml aliquot of a 0.001 wt. % ammonium persulfate initiator and 0.005 wt. % sodium phosphate dibasic heptahydrate aqueous solution was then added. TFE was supplied to the reactor to maintain a pressure of 1.0 MPa throughout the polymerization. The initiator solution was fed continuously at 1.0 ml/hour through the end of the reaction period. After a total of 104 g monomer mixture had been supplied to the reactor, monomer addition was discontinued and the reactor was purged of residual monomer. The total reaction time was 11 hours. The resulting fluoroelastomer latex was coagulated by addition of an aqueous aluminum sulfate solution and the filtered fluoroelastomer was washed with deionized water. The polymer crumb was dried for two days at 60° C. The polymer, comprised of 77.2 mol. % TFE and 22.8 mol. % CF₃CH₂—OCF═CF₂, was an amorphous fluoroelastomer having a glass transition temperature of −9.5° C., as determined by differential scanning calorimetry (heating mode, 10° C./minute, inflection point of transition).

What is claimed is:

1. An α,α-dihydrofluorovinyl ether having the general formula R_{f}—[CH₂]ₙ—OCF═CF₂, wherein n is 1 or 2, and R_{f} is selected from the group consisting of a perfluoroalkoxy group and a fluoroalkoxy group.

2. An α,α-dihydrofluorovinyl ether of claim 1 wherein n is 1.

3. An α,α-dihydrofluorovinyl ether of claim 2 selected from the group consisting of CH₃O—(CF₂)₂—CH₂—OCF═CF₂; CF₃O—(CF₂O)ₚ—CF₂—CH₂—OCF═CF₂ wherein p is an integer between 1 and 10; and C₃F₇O—[CF(CF₃)CF₂O]_{q}—CF(CF₃)—CH₂—OCF═CF₂ wherein q is an integer between 1 and 20.

4. A homopolymer of an α,α-dihydrofluorovinyl ether having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group.

5. A homopolymer of claim 4 wherein said ether is selected from the group consisting of CH₃O—(CF₂)₂—CH₂—OCF═CF₂; CF₃—CH₂OCF═CF₂; CF₃O—(CF₂O)ₚ—CF₂—CH₂—OCF═CF₂ wherein p is an integer between 1 and 10; C₃F₇O—[CF(CF₃)CF₂O]_{q}—CF(CF₃)—CH₂—OCF═CF₂ wherein q is an integer between 1 and 20; CF₃CF₂CF₂CF₂CH₂—OCF═CF₂; and H—CF₂CF₂CF₂CF₂—CH₂OCF═CF₂.

6. A copolymer comprising:
A) more than 22 mole percent of copolymerized units of an α,α-dihydrofluorovinyl ether monomer having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group; and
B) copolymerized units of at least one other copolymerizable monomer, said mole percent based on total moles of all copolymerized monomers in said copolymer.

7. A copolymer of claim 6 wherein said ether is selected from the group consisting of CH₃O—(CF₂)₂—CH₂—OCF═CF₂; CF₃—CH₂OCF═CF₂; CF₃O—(CF₂O)ₚ—CF₂—CH₂—OCF═CF₂ wherein p is an integer between 1 and 10; C₃F₇O—[CF(CF₃)CF₂O]_{q}—CF(CF₃)—CH₂—OCF═CF₂ wherein q is an integer between 1 and 20; CF₃CF₂CF₂CF₂CH₂—OCF═CF₂; and H—CF₂CF₂CF₂CF₂—CH₂OCF═CF₂.

8. A copolymer of claim 6 wherein said copolymerizable monomer is selected from the group consisting of tetrafluoroethylene; chlorotrifluoroethylene; hexafluoropropylene; vinylidene fluoride; perfluoro(methyl vinyl ether); perfluoro(propyl vinyl ether); ethylene; propylene; CF₂═CFOCF₂CF(CF₃)—O—CF₂CF₂—COOCH₃; CF₂═CFOCF₂CF(CF₃)—O—CF₂CF₂—SO₂F; and CF₂═CFO—[CF₂CF(CF₃)O]ₙR_{f} wherein n is an integer between 1 and 6 and R_{f} is a perfluoroalkyl or perfluoroalkoxy group containing between 1 and 8 carbon atoms.

9. A process for preparation of a fluoroelastomer comprising:
A) emulsifying a mixture comprising i) an α,α-dihydrofluorovinyl ether having the general formula R_{f}—[CH₂]ₙ—OCF═CF₂, wherein n is 1 or 2, and R_{f} is selected from the group consisting of a perfluoroalkyl group, a perfluoroalkoxy group, a fluoroalkyl group and a fluoroalkoxy group; ii) surfactant and iii) water to form an emulsified α,α-dihydrofluorovinyl ether; and
B. copolymerizing said emulsified α,α-dihydrofluorovinyl ether with at least one gaseous fluoromonomer to form a fluoroelastomer.

10. A process of claim 9 wherein said surfactant is a fluorosurfactant.

11. A process of claim 9 wherein said mixture to be emulsified in step A) further comprises a fluorinated solvent.
